(19) United States
(12) Patent Application Publication
(10) Pub. No.: US 2020/0226699 A1
(43) Pub. Date: Jul. 16, 2020

(54) REAL ESTATE TRANSACTION SYSTEM AND METHOD

(71) Applicants: Amir Abbas Golband, Richmond Hill (CA); Alireza Golband, Richmond Hill (CA)

(72) Inventors: Amir Abbas Golband, Richmond Hill (CA); Alireza Golband, Richmond Hill (CA)

(21) Appl. No.: 16/265,962

(22) Filed: Feb. 1, 2019

(30) Foreign Application Priority Data
Jan. 15, 2019 (CA) 3030077

(51) Int. Cl. G06Q 50/16; H04W 4/02; G06Q 20/02

(52) U.S. Cl. CPC G06Q 50/163; G06Q 20/02; H04W 4/023

(57) ABSTRACT

The present invention relates to a real estate transaction system, comprising: a peer-to-peer client application, the client application presenting information on available brokerages and agents to prospective and current clients and comprising one or more of the following modules: an agent biography module; a geographical location module; and a value calculation module. The system further comprises a peer-to-peer agent application, the agent application presenting information on work progress on real estate transactions for agents, the agent application being accessible by both the agent and the brokerage and comprising one or more of the following modules: a workflow tracking module; an accounting module; and a payment module. The system is operative to support a client-agent interaction for one side, the side being either buyer or seller, for a real estate transaction.

### FIELD OF THE INVENTION

The present specification relates generally to systems and methods for facilitating real estate transactions and more particularly to a system and method for facilitating transactions and interactions between real estate brokerages, real estate agents and clients.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

The initiation and execution of a real estate transaction and the relationship between the parties involved appears complex and is highly regulated. Executing a real estate transaction is generally of great significance to the client and requires trust and confidence in their agent and brokerage for the transaction. A real estate transaction between two parties is most often facilitated by a brokerage for one or both clients (buyer and seller). Further, there are often multiple agents (salespersons) associated with a brokerage to assist in transactions. Compensation to both the agent and the brokerage is typically derived as a percentage commission on the sale price of the property.

One of the challenges encountered by clients, both prospective and current, is the uncertainty created by tying the commission to the final sale price. A secondary factor is that using a percentage commission motivates agents to seek higher prices, which may not be in their client's interest. For example, where the completion of the transaction is more important than the final price.

However, to date, the ability to use advances in technology enable clients to connect with an agent they trust, and for agent and brokerages to track activities associated with transaction has been limited to date. In addition, there have been minimal attempts to leverage applications to mitigate the uncertainty around commission and payments.

While there are some applications known in the art, it would be desirable to have an application which mitigates some of the disadvantages.

Accordingly, there remains a need for improvements in the art.

### SUMMARY OF THE INVENTION

In accordance with an aspect of the invention, there is provided a real estate transaction system for use by clients, agents and brokerages.

According to an embodiment of the invention, there is provided a real estate transaction system, comprising: a peer-to-peer client application, the client application presenting information on available brokerages and agents to prospective and current clients and comprising one or more of the following modules: an agent biography module; a geographical location module; and a value calculation module. The system further comprises a peer-to-peer agent application, the agent application presenting information on work progress on real estate transactions for agents, the agent application being accessible by both the agent and the brokerage and comprising one or more of the following modules: a workflow tracking module; an accounting module; and a payment module. The system is operative to support a client-agent interaction for one side, the side being either buyer or seller, for a real estate transaction.

According to a further embodiment of the invention, there is provided a method of executing a real estate transaction for a client, the client being one of a buyer or a seller, comprising: connecting an agent with the client, the agent associated with a brokerage, through a peer-to-peer client application, the client application including one or more of: an agent biography module; a geographical location module; and a value calculation module. The method further comprises tracking progress of the real estate transaction through a peer-to-peer agent application, the agent application accessible to the agent and the brokerage, the agent application including: a workflow tracking module; an accounting module; and a payment module.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a block diagram of a real estate transaction system according to an embodiment.

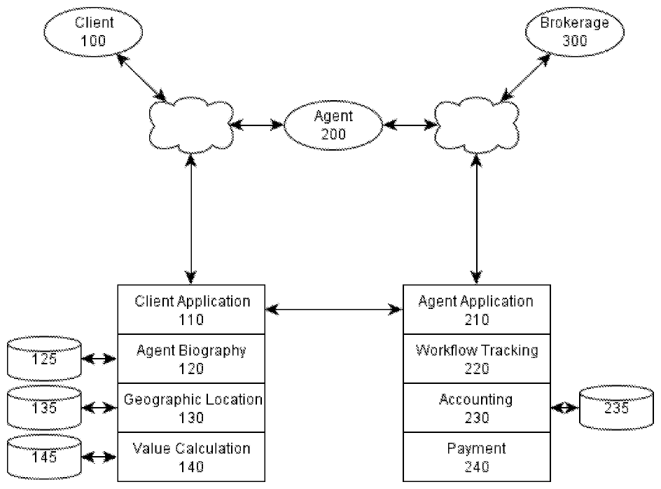

Like reference numerals indicated like or corresponding elements in the drawings.

### DETAILED DESCRIPTION OF THE EMBODIMENTS

The present invention relates to generally to systems and methods for facilitating real estate transactions and more particularly to a system and method for facilitating transactions and interactions between real estate brokerages, real estate agents and clients.

According to an embodiment of the present invention, a real estate transaction system is provided which enables communication and information sharing between clients 100, agents 200 and brokerages 300. The first element of the system is a peer-to-peer client application 110 for communication between clients 100 (existing or prospective) and agents 200. The client application modules may include an agent biography module 120, including an agent database 125, a geographic location module 130 (e.g. GPS or similar and digitized maps) including a location database 135, and a value calculation module 140 for property appraisals and commissions, which may include a valuation database 145.

The agent biography module 120 may include professional and personal information about individual agents who have granted permission to the system, including any brokerages the agents are associated to. The agent database 125 may include information provided by the agent, as well as connections to other information databases, including social media (e.g. Facebook, Twitter, LinkedIn). The agent biography module 120 may further include a contact component to allow clients to contact agents to express their interest in representation. The agent biography module 120 may also include data tracking so that agents may track access to their profile, including number of views and location of the viewing source (gathered from the geographic location module 130).

The geographic location module 130 allows the application to determine location, if needed, and to provide map information for client and agent reference. For example, when buying a property, a client may prefer to seek an agent familiar with the location they are targeting for purchase. Conversely, when selling, a client may prefer an agent familiar with their current location. Additionally, the geographic location module 130 may include a location database 135 with content and connections to external databases including real estate databases (e.g. MLS) to allow clients to view and preview properties for sale through those databases and location and map databases (e.g. Google Maps).

The value calculation module 140 is designed for agents 200 to generate appraisal values for listed properties and to calculate the resultant commission based on the appraised value, which may then be shared with the client 100. The appraisal may be based on multiple factors (location, recent comparable sales, trendlines), and data used may be retrieved from valuation database 145 with connections to private and public data to assist in ensuring accuracy and recency of the calculations. The appraisal calculation may further include client and agent input as to the expected sale price of the property. In any event, once the appraisal and commission are calculated by the brokerage, the values are locked, so they are viewable but not editable by the client and agent.

By integrating the appraisal and commission calculation, a fixed value for the commission may be calculated and shared among the agent and client by the brokerage. With a fixed value, both the client 100 and agent 200 may calculate projected cash flows based on the expected sale without concern over future variance. Similarly, the brokerage 300 may calculate their commission from the agent for the transaction from that fixed value. While various methods of calculating commissions are known, most are often percentage-based on the actual sale value. By linking the appraisal and commission calculators, other commission systems may be devised. In particular, a fixed rate commission may be based off the appraised value, reducing incentives to the agent to over-inflate the price (to increase commission) which may not be in the interests of the client. Additionally, the commission may be calculated based on price ranges (e.g. every $100,000 in price increases the fixed commission value) and may be either linear or non-linear.

The second element of the system is a peer-to-peer agent application 210 for use by agents 200 and brokerages 300. The agent application 210 may include a workflow tracking module 220, an accounting module 230 and a payment module 240. The agent application 210 may further include connections to one or more client applications 110 to access and share information between applications.

The workflow tracking module 220 is used by agents 200 and brokerages 300 to track the workflow of the property transactions under the control of the agent 200 and the brokerage 300. The transaction workflow may be customized to each transaction and may include fixed items required for every transaction (e.g. representation form signed, transaction closing record) and optional items that may or may not be used for every transaction (e.g. staging, home inspection).

The accounting module 230 is used to track appraised value and commission values for property transactions assigned to the agent 200 and the brokerage 300. The accounting module may track the appraised value of the property, the posted sale price, and the commission associate with the sale. Additionally, other financial transactions, such as payment for vendors (staging, renovation, etc.) and agreed commission splits may be tracked as well. The accounting module may further pull information from external databases 235 and incorporate that information into the accounting system as well, such as sales tax requirements and amounts.

The payment module 240 may be coupled to or integrated into the accounting module to enable payments to be made as required. Generally, the actual payment may be executed through an existing secure system. Payment may be made to vendors as discussed above, or from the brokerage to the agent (commission) on completion of the transaction. The payment module 240 may be further coupled to the workflow module 220 to enable automatic marking of completion of payment tasks once a payment is made through the payment module 220. Additionally, the transaction may be recorded as required in the accounting module 230.

In operation, a client (prospective or existing) accesses the client application, reviews the agent biographies, and selects an agent to represent them. The client may be presented agents for selection by selecting a map area and being presented with a list of agents who operate in that area. Alternatively, the client may select an agent and be presented with the geographic region where that agent prefers to operate.

Once the client has selected an agent to contact and the client-agent relationship is established, then the base workflow is created for the agent and brokerage. This workflow may then be modified to meet the needs and demands of the client and the agent. The progress of the transaction may then be tracked by both the agent and the brokerage against the workflow. As discussed above, one of the key steps at the beginning of the workflow is to establish an appraisal value for the property via the value calculation module, and then calculated the corresponding commission value.

As described above, the embodied system and method is applied to a residential real estate sale transaction. However, the system and method may be applied to any type of real estate transaction, being residential sale, commercial sale, residential lease, commercial lease, and pre-construction sale, among others.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for insulating, protecting and installing are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A real estate transaction system, comprising:
a peer-to-peer client application, the client application presenting information on available brokerages and agents to prospective and current clients and comprising one or more of the following modules:
an agent biography module;
a geographical location module; and
a value calculation module;
a peer-to-peer agent application, the agent application presenting information on work progress on real estate transactions for agents, the agent application being accessible by both the agent and the brokerage and comprising one or more of the following modules:
a workflow tracking module;
an accounting module; and
a payment module,
wherein the system is operative to support a client-agent interaction for one side, the side being either buyer or seller, for a real estate transaction

2. The real estate transaction system of claim 1, wherein the real estate transaction is one of: residential sale, residential lease, commercial sale, commercial lease, and pre-construction sale.

3. The real estate transaction system of claim 1, wherein the agent biography module includes external database connections as part of agent biographies.

4. The real estate transaction system of claim 3, wherein the external database connections include one or more of: Facebook, Twitter, LinkedIn and Google.

5. The real estate transaction system of claim 1, wherein the geographical location module includes connections to an external database of available real estate properties for sale in a geographic region.

6. The real estate transaction system of claim 1, wherein the geographic location module displays one or more of: one or more agents who operate in a specified geographic region and one or more geographic regions where a specified agent operates.

7. The real estate transaction system of claim 1, wherein the value calculation module calculates an appraised value for the real estate property.

8. The real estate transaction system of claim 7, wherein the value calculation module further calculates a commission value based on the appraised value.

9. The real estate transaction system of claim 8, wherein the commission value is a fixed amount.

10. The real estate transaction system of claim 1, wherein the workflow tracking module includes, for each transaction, a set of required workflow activities and a set of optional workflow activities.

11. The real estate transaction system of claim 1, wherein the payment module, accounting module and workflow module are connected such that interactions in one of these modules automatically updates the other two modules.

12. A method of executing a real estate transaction for a client, the client being one of a buyer or a seller, comprising:
connecting an agent with the client, the agent associated with a brokerage, through a peer-to-peer client application, the client application including one or more of:
an agent biography module;
a geographical location module; and
a value calculation module,
tracking progress of the real estate transaction through a peer-to-peer agent application, the agent application accessible to the agent and the brokerage, the agent application including:
a workflow tracking module;
an accounting module; and
a payment module.

13. The method of claim 12, wherein the real estate transaction is one of: residential sale, residential lease, commercial sale, commercial lease, and pre-construction sale.

14. The method of claim 12, wherein the client application and the agent application further include connections to external databases.

15. The method of claim 14, wherein the external database include one or more of: Facebook, Twitter, LinkedIn, Google and an external database of available real estate properties for sale in a geographic region.

16. The method of claim 12, wherein one of the steps of the real estate transaction includes calculating an appraised value for the real estate property via the value calculation module.

17. The method of claim 16, further including calculating a commission value based on the appraised value via the value calculation module.

18. The method of claim 17, wherein the commission value is a fixed amount.

19. The method of claim 12, wherein the workflow tracking module includes, for each transaction, a set of required workflow activities and a set of optional workflow activities.

20. The method of claim 12, wherein the geographic location module displays one or more of: one or more agents who operate in a specified geographic region and one or more geographic regions where a specified agent operates.
